(19) United States
(12) Patent Application Publication
(10) Pub. No.: US 2014/0052507 A1
(43) Pub. Date: Feb. 20, 2014

(54) METHODS AND SYSTEMS FOR TARGETING MOBILE DEVICES DURING CHARGING

(71) Applicants: Anupam SETH, Urbana, IL (US); Allie K. Watfa, Urbana, IL (US); Dale Nussel, Mahomet, IL (US); Jonathan Kilroy, Champaign, IL (US)

(72) Inventors: Anupam SETH, Urbana, IL (US); Allie K. Watfa, Urbana, IL (US); Dale Nussel, Mahomet, IL (US); Jonathan Kilroy, Champaign, IL (US)

(73) Assignee: Yahoo! Inc., Sunnyvale, CA (US)

(21) Appl. No.: 13/588,813

(22) Filed: Aug. 17, 2012

(51) Int. Cl. G06Q 30/02

(52) U.S. Cl. 705/14.1; 705/14.64

(57) ABSTRACT

Methods and systems for targeting advertisements to mobile electronic devices while the devices are being charged are disclosed. An indication is received from a mobile electronic device that the device is currently being charged. Targeting criteria are determined based at least in part on usage of the mobile electronic device during a time period between the last charge and the current charge. An advertisement is selected based at least in part on the targeting criteria. The advertisement is transmitted to the mobile electronic device for display on the mobile electronic device.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

One particular target audience of interest to advertisers is users of mobile devices. Sales of internet-enabled mobile devices, such as smartphones, tablets, netbooks, laptops, etc. have experienced tremendous growth over the last few years. What's more, sales of mobile devices are projected to grow even further in the coming years.

There is a need for improved techniques in targeting users of mobile devices with advertisements without obstructing the use of the mobile device, taking up unnecessary screen space, and excessively draining the battery.

### SUMMARY

Some embodiments of the invention provide systems and methods for targeting mobile device users with advertisements. An indication may be received at a server computer from a mobile electronic device that the mobile electronic device is currently being charged. The indication may include usage information of the mobile electronic device during a time period between a time when the mobile electronic device was last charged and a time of the current charge. The usage information may include for example, the applications used, web pages visited, music played, pictures viewed, etc. during the time period between the last charge and the current charge. In one embodiment, the time when the mobile device was last charged may be a time when the mobile device was last disconnected from an electrical outlet or from another device, such as a PC. In other embodiments, the time when the mobile device was last charged may be the time when the mobile device's battery was fully charged. The time of the current charge may be the time when the mobile device is connected to an electrical outlet or to another device, such as a PC. In one embodiment, the indication may be one or more data packets transmitted by a software application running on the mobile device. The software application may be configured to detect when the mobile device is connected and disconnected to/from an electrical outlet, and when the mobile device is connected and disconnected to/from another device (e.g., charging a smart phone by connecting it to a PC using a USB cable). The software application may be configured to transmit the indication in response to detecting that the mobile device is being charged either by being connected to an electrical outlet or by being connected to another device (e.g., connected to a PC using a USB cable). The indication may be transmitted to for example, one or more server computers 108 (FIG. 1). In some embodiments, the indication may include additional information such as location information such as the current location of the mobile device. In some embodiments, the indication may also include identification information of the user. The identification information may be used at the server computer to retrieve user profile information of the user.

One or more targeting criteria may be determined based at least in part on the usage information. The usage of the mobile electronic device may be determined by monitoring predetermined activities on the mobile device using for example, the software application discussed above. As discussed above, the usage information may include for example, the applications used, web pages visited, music played, pictures viewed, etc. during the time period between the last charge and the current charge. In some embodiments, the targeting criteria may also be determined based at least in part on user profile information.

An advertisement may be selected based at least in part on the one or more targeting criteria. In some embodiments, the user may pre-select one or more advertisement categories, and advertisements for display on the mobile device may be selected from the user-selected categories. The advertisement may be transmitted to the mobile electronic device for display on the mobile electronic device, wherein the advertisement is displayed for a predetermined duration while the mobile electronic device is being charged. In one embodiment, the advertisement may be displayed for the duration of the charge. In other words, the advertisement is displayed for as long as the device is being charged, and disconnecting the device from the electrical outlet, or from another device (e.g., a PC) halts display of the advertisement. In some embodiments, the advertisement may include a user interface element that allows the user to interact with the advertisement to for example, obtain more information about the advertisement. In other embodiments, the advertisement may be displayed for example, for a fixed duration (e.g., 30 seconds).

A financial incentive may be provided to a user in exchange for allowing the advertisement to be displayed on the mobile electronic device. The incentive may include for example, discount coupons, gift cards, rewards points, etc. In one embodiment, the financial incentives may be selected based on user interests determined based on the usage of the device. A sale of a software application to the user may be facilitated at least partly in exchange for the financial incentive, wherein the software application is configured to run on the mobile electronic device. In other words, the user may at least partly exchange the rewards points, coupons, gift cards, etc. for applications which may be used on the mobile device.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 is an exemplary distributed computer system according to one embodiment of the invention;

FIG. 2 is an exemplary flow diagram illustrating a method according to one embodiment of the invention;

FIG. 3 is an exemplary flow diagram illustrating a method according to one embodiment of the invention;

FIG. 4 is an exemplary block diagram according to one embodiment of the invention; and

FIG. 5 is a diagram of an exemplary advertisement according to one embodiment of the invention.

### DETAILED DESCRIPTION

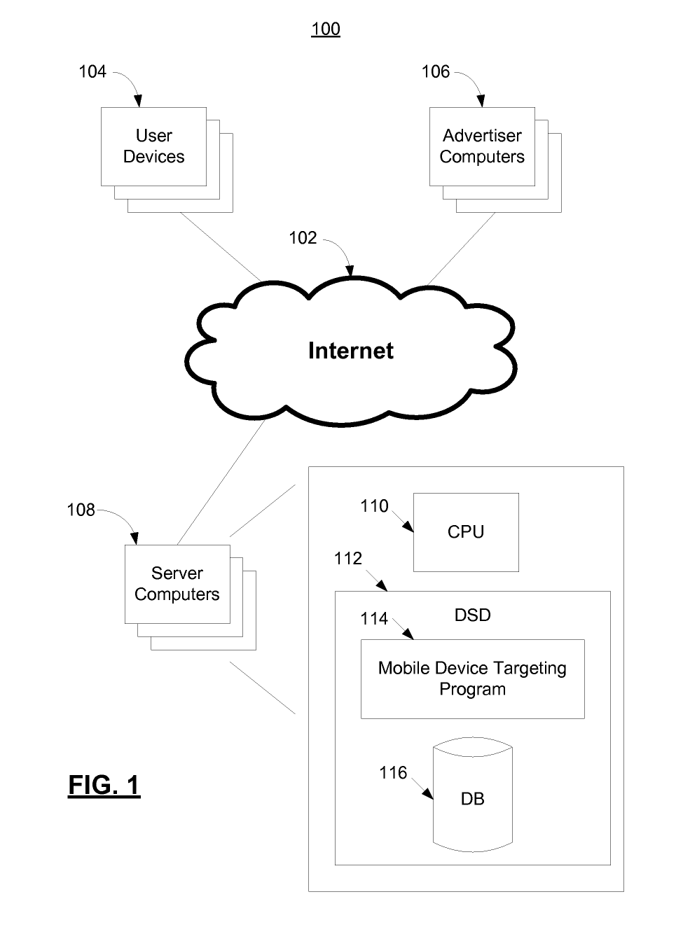

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user devices 104 may be or include netbook and laptop PCs, as well as, wireless, mobile, or handheld devices such as smartphones, PDAs, tablets, etc.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Mobile Device Targeting Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

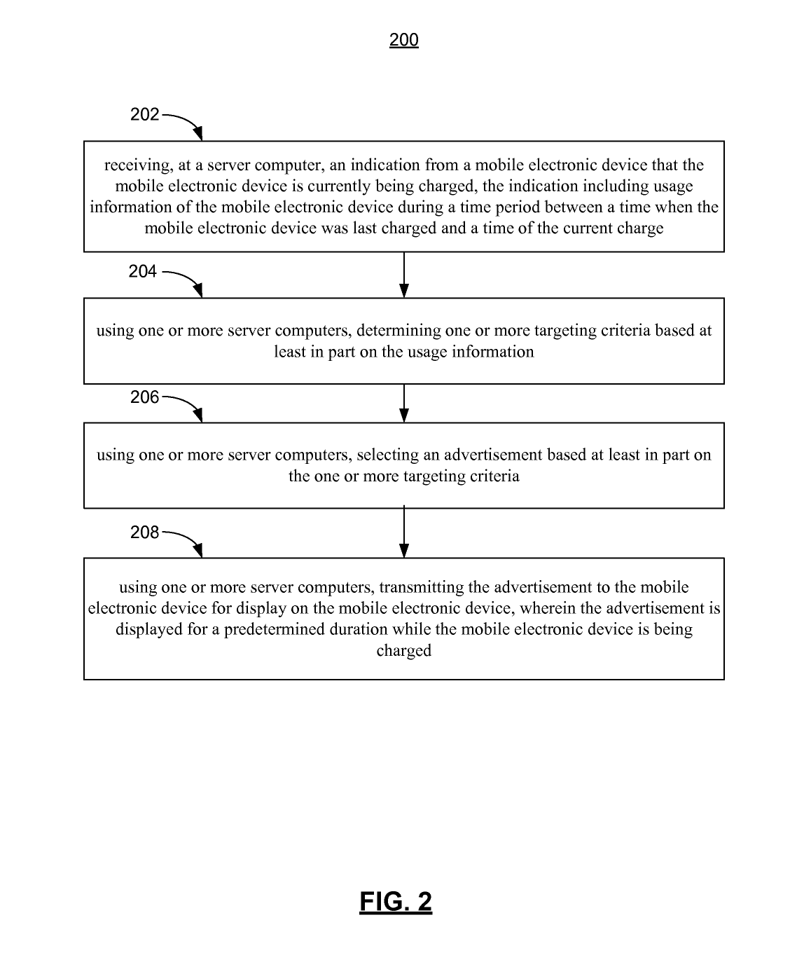

FIG. 2 is a flow diagram illustrating a method 200 according to one embodiment of the invention. At step 202, an indication may be received at a server computer from a mobile electronic device that the mobile electronic device is currently being charged. The indication may include usage information of the mobile electronic device during a time period between a time when the mobile electronic device was last charged and a time of the current charge. The usage information may include for example, the applications used, web pages visited, music played, pictures viewed, etc. during the time period between the last charge and the current charge. In one embodiment, the time when the mobile device was last charged may be a time when the mobile device was last disconnected from an electrical outlet or from another device, such as a PC. In other embodiments, the time when the mobile device was last charged may be the time when the mobile device's battery was fully charged. The time of the current charge may be the time when the mobile device is connected to an electrical outlet or to another device, such as a PC. In one embodiment, the indication may be one or more data packets transmitted by a software application running on the mobile device. The software application may be configured to detect when the mobile device is connected and disconnected to/from an electrical outlet, and when the mobile device is connected and disconnected to/from another device (e.g., charging a smart phone by connecting it to a PC using a USB cable). The software application may be configured to transmit the indication in response to detecting that the mobile device is being charged either by being connected to an electrical outlet or by being connected to another device (e.g., connected to a PC using a USB cable). The indication may be transmitted to for example, one or more server computers 108 (FIG. 1). In some embodiments, the indication may include additional information such as location information such as the current location of the mobile device. In some embodiments, the indication may also include identification information of the user. The identification information may be used at the server computer to retrieve user profile information of the user.

At step 204, using one or more server computers, one or more targeting criteria may be determined based at least in part on the usage information. The usage of the mobile electronic device may be determined by monitoring predetermined activities on the mobile device using for example, the software application discussed above. As discussed above, the usage information may include for example, the applications used, web pages visited, music played, pictures viewed, etc. during the time period between the last charge and the current charge. In some embodiments, the targeting criteria may also be determined based at least in part on user profile information.

At step 206, using one or more server computers, an advertisement may be selected based at least in part on the one or more targeting criteria. In some embodiments, the user may pre-select one or more advertisement categories, and advertisements for display on the mobile device may be selected from the user-selected categories. At step 208, using one or more server computers, the advertisement may be transmitted to the mobile electronic device for display on the mobile electronic device, wherein the advertisement is displayed for a predetermined duration while the mobile electronic device is being charged. In one embodiment, the advertisement may be displayed for the duration of the charge. In other words, the advertisement is displayed for as long as the device is being charged, and disconnecting the device from the electrical outlet, or from another device (e.g., a PC) halts display of the advertisement. In some embodiments, the advertisement may include a user interface element that allows the user to interact with the advertisement to for example, obtain more information about the advertisement. In other embodiments, the advertisement may be displayed for example, for a fixed duration (e.g., 30 seconds).

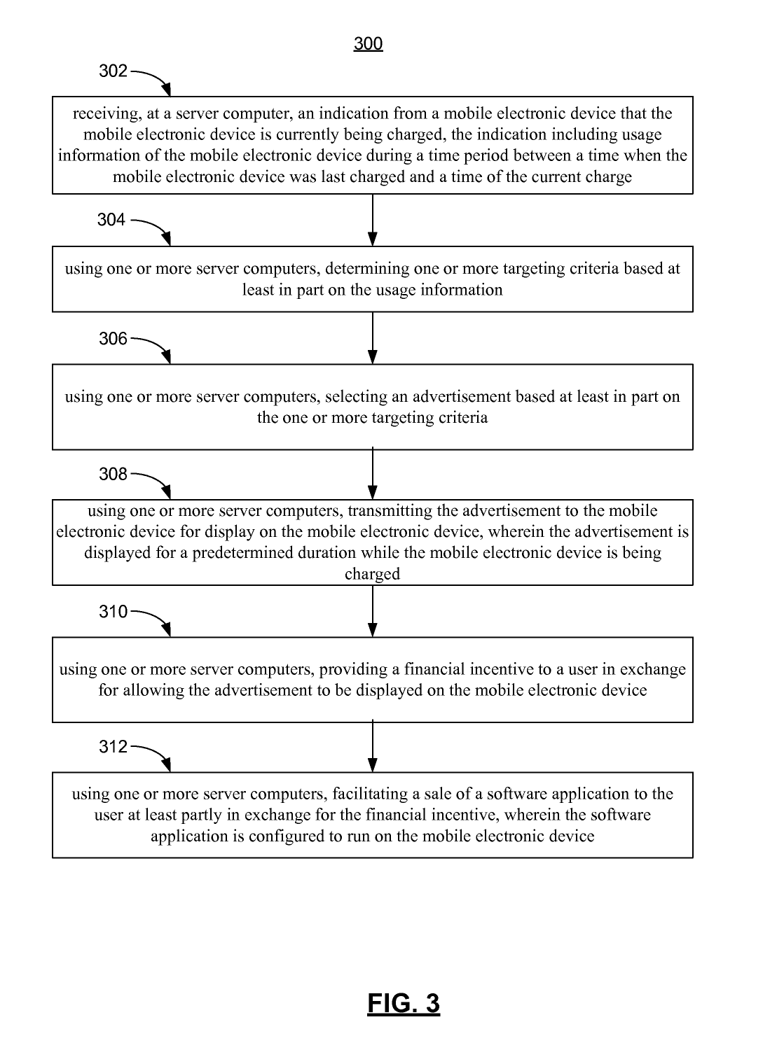

FIG. 3 is a flow diagram illustrating a method 300 according to one embodiment of the invention. At step 302, an indication may be received at a server computer from a mobile electronic device that the mobile electronic device is currently being charged. The indication may include usage information of the mobile electronic device during a time period between a time when the mobile electronic device was last charged and a time of the current charge. The usage information may include for example, the applications used, web pages visited, music played, pictures viewed, etc. during the time period between the last charge and the current charge. In one embodiment, the time when the mobile device was last charged may be a time when the mobile device was last disconnected from an electrical outlet or from another device, such as a PC. In other embodiments, the time when the mobile device was last charged may be the time when the mobile device's battery was fully charged. The time of the current charge may be the time when the mobile device is connected to an electrical outlet or to another device, such as a PC. In one embodiment, the indication may be one or more data packets transmitted by a software application running on the mobile device. The software application may be configured to detect when the mobile device is connected and disconnected from an electrical outlet, and when the mobile device is connected and disconnected to/from another device (e.g., charging a smart phone by connecting it to a PC using a USB cable). The software application may be configured to transmit the indication in response to detecting that the mobile device is being charged either by being connected to an electrical outlet or by being connected to another device (e.g., connected to a PC using a USB cable). The indication may be transmitted to for example, one or more server computers 108 (FIG. 1). In some embodiments, the indication may include additional information such as location information such as the current location of the mobile device. In some embodiments, the indication may also include identification information of the user. The identification information may be used at the server computer to retrieve user profile information of the user.

At step 304, using one or more server computers, one or more targeting criteria may be determined based at least in part on the usage information. The usage of the mobile electronic device may be determined by monitoring predetermined activities on the mobile device using for example, the software application discussed above. As discussed above, the usage information may include for example, the applications used, web pages visited, music played, pictures viewed, etc. during the time period between the last charge and the current charge. In some embodiments, the targeting criteria may also be determined based at least in part on user profile information.

At step 306, using one or more server computers, an advertisement may be selected based at least in part on the one or more targeting criteria. In some embodiments, the user may pre-select one or more advertisement categories, and advertisements for display on the mobile device may be selected from the user-selected categories. At step 308, using one or more server computers, the advertisement may be transmitted to the mobile electronic device for display on the mobile electronic device, wherein the advertisement is displayed for a predetermined duration while the mobile electronic device is being charged. In one embodiment, the advertisement may be displayed for the duration of the charge. In other words, the advertisement is displayed for as long as the device is being charged, and disconnecting the device from the electrical outlet, or from another device (e.g., a PC) halts display of the advertisement. In some embodiments, the advertisement may include a user interface element that allows the user to interact with the advertisement to for example, obtain more information about the advertisement. In other embodiments, the advertisement may be displayed for example, for a fixed duration (e.g., 30 seconds).

At step 310, using one or more server computers, a financial incentive may be provided to a user in exchange for allowing the advertisement to be displayed on the mobile electronic device. The incentive may include for example, discount coupons, gift cards, rewards points, etc. In one embodiment, the financial incentives may be selected based on user interests determined based on the usage of the device. In some embodiments, as more advertisements are displayed, the user may build up credit that may be used to purchase applications for the mobile device (or for other mobile devices). The amount of credit may be determined using the following formula:

Credit=(number of ads shown*number of ads clicked on)+(duration of charging time equalized to the time of day)+(quality of the ad)

In this formula, number of ads shown represents the number of advertisements displayed during the duration of the charge; number of ads clicked on represents the number of advertisements clicked by the user; duration of charging time equalized to the time of day is used to account for the fact that the time of day when the mobile device is being charged may affect the effectiveness of the advertisement. For example, if the mobile device is being charged overnight when the user is sleeping, the advertisement isn't being viewed the user. Quality of the ad represents the relevance of the advertisement to the particular user's interests.

At step 312, using one or more server computers, a sale of a software application to the user may be facilitated at least partly in exchange for the financial incentive, wherein the software application is configured to run on the mobile electronic device. In other words, the user may at least partly exchange the rewards points, coupons, gift cards, etc. for applications which may be used on the mobile device.

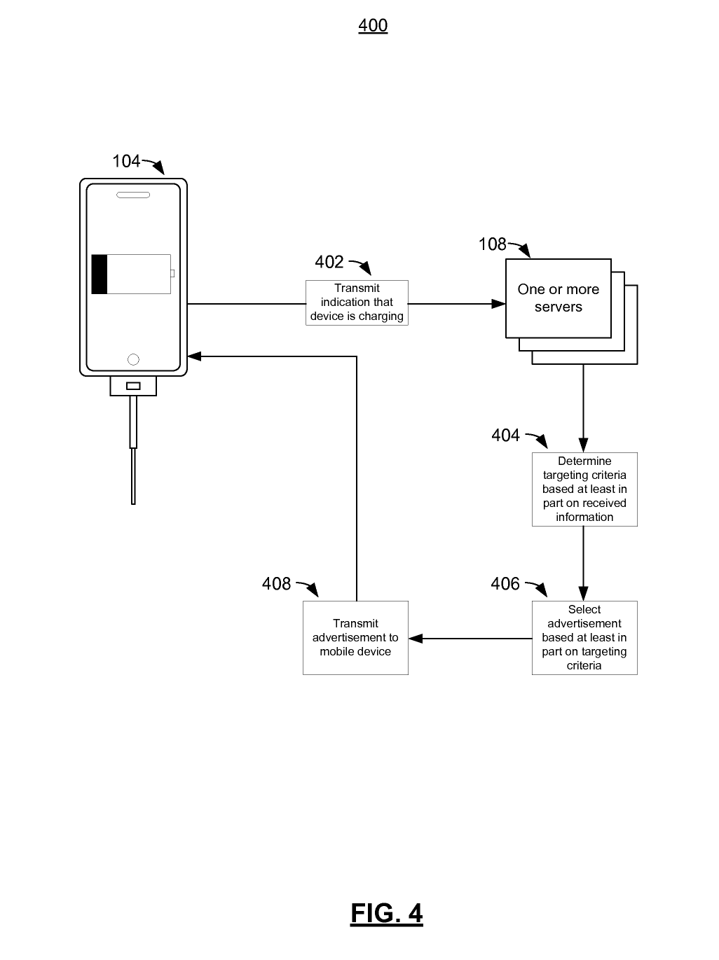

FIG. 4 illustrates a block diagram of a system 400 according to one embodiment of the invention. As depicted in block 402, when mobile electronic device 104 is being charged, whether by being connected to a wall electrical outlet, or by being connected to another device, such as a PC, mobile electronic device 104 transmits an indication to one or more servers 108. The indication may be one or more data packets, and may include usage information of the mobile electronic device during a time period between a time when the mobile electronic device was last charged and a time of the current charge. In one embodiment, the indication may also include for example, current location information of the mobile electronic device. The usage information may include for example, the applications used, web pages visited, music played, pictures viewed, etc. during the time period between the last charge and the current charge. In one embodiment, the time when the mobile device was last charged may be a time when the mobile device was last disconnected from an electrical outlet or from another device, such as a PC. In other embodiments, the time when the mobile device was last charged may be the time when the mobile device's battery was fully charged. The time of the current charge may be the time when the mobile device is connected to an electrical outlet or to another device, such as a PC.

One or more servers 108 may, as shown in block 404, determine one or more targeting criteria based at least in part on the received information. In some embodiments, the targeting criteria may also be determined based at least in part on user profile information. The user profile information may be stored on one or more servers 108, and may be retrieved using user identification information included in the indication. In block 406, one or more advertisements may be selected based at least in part on the targeting criteria. The advertisement(s) may be transmitted to mobile device 104 in block 408. In one embodiment, the advertisement may be displayed for the duration of the charge. In other words, the advertisement is displayed for as long as the device is being charged, and disconnecting the device from the electrical outlet, or from another device (e.g., a PC) halts display of the advertisement. In other embodiments, the advertisement may be displayed for example, for a fixed duration (e.g., 30 seconds).

In one embodiment, one or more servers 108 may retrieve social networking information including pictures, videos, posts, status updates, etc. posted by the user's social networking contacts while mobile device 104 is being charged, and transmit the social networking information to mobile device 104 for display on mobile device 104 alongside the advertisement. In other words, any updates to the user's social network that happened while the device was being charged, may also be displayed on mobile device 104 along with the advertisement. The social networking updates may be configured such that they automatically scroll in a predetermined portion of the display while the advertisement is being displayed.

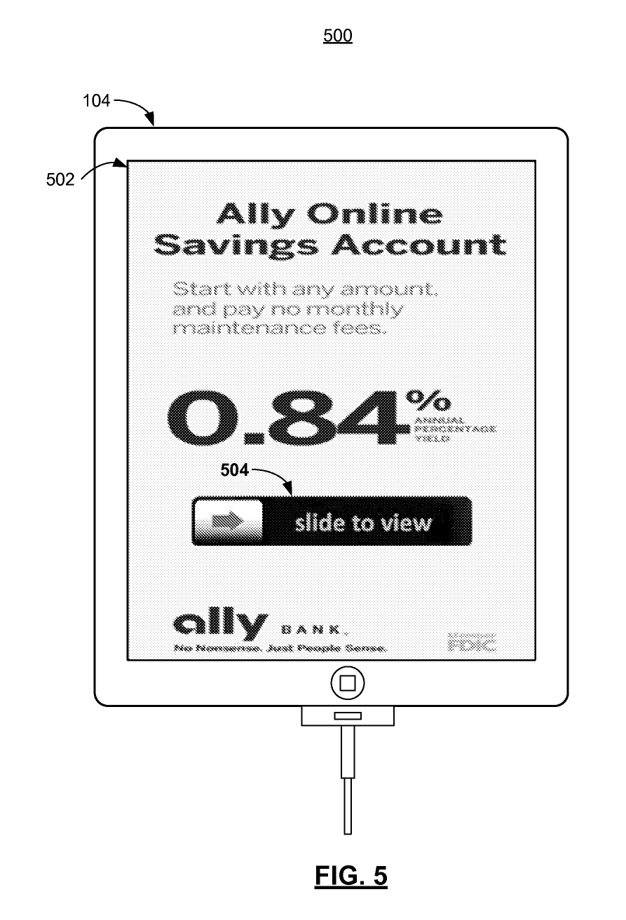

FIG. 5 illustrates a diagram of an exemplary advertisement according to one embodiment of the invention. Advertisement 502 is displayed on mobile device 104 while mobile device 104 is being charged. As discussed above, in one embodiment, the advertisement may be displayed for the duration of the charge. In other words, the advertisement is displayed for as long as the device is being charged, and disconnecting the device from the electrical outlet, or from another device (e.g., a PC) halts display of the advertisement. In other embodiments, the advertisement may be displayed for example, for a fixed duration (e.g., 30 seconds). Advertisement 502 may also include user interface element 504 that allows the user to interact with advertisement 502. In this example, swiping across the screen would display more information about the advertisement to the user.

In some embodiments, alternatively, or in addition to advertisements being displayed on the mobile device, advertisements may be displayed when the user unlocks the device. For example, advertisements may be displayed on the lock screen of the mobile device. In this embodiment, the user may chose to have the battery of the mobile device be “sponsored” by a particular brand. As long as the user is using the “sponsored” battery, advertisements may be displayed on the lock screen. When the performance of the battery degrades below a predetermined threshold (e.g., charging capacity is below a certain threshold), they user may receive a free replacement battery from the sponsor.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

1. A method comprising:
receiving, at a server computer, an indication from a mobile electronic device that the mobile electronic device is currently being charged, the indication including usage information of the mobile electronic device during a time period between a time when the mobile electronic device was last charged and a time of the current charge;
using one or more server computers, determining one or more targeting criteria based at least in part on the usage information;
using one or more server computers, selecting an advertisement based at least in part on the one or more targeting criteria; and
using one or more server computers, transmitting the advertisement to the mobile electronic device for display on the mobile electronic device, wherein the advertisement is displayed for a predetermined duration while the mobile electronic device is being charged.

2. The method of claim 1, wherein the usage information comprises types of applications used and type of online content viewed during the time period between the last charge and the current charge.

3. The method of claim 1, wherein determining the targeting criteria further comprises determining the targeting criteria based at least in part on user profile information.

4. The method of claim 1, wherein the indication includes location information.

5. The method of claim 4, wherein determining the targeting criteria further comprises determining the targeting criteria based at least in part on the location information.

6. The method of claim 1, wherein the predetermined duration is a duration of the current charge.

7. The method of claim 1, further comprising:
using one or more server computers, providing a financial incentive to a user in exchange for allowing the advertisement to be displayed on the mobile electronic device.

8. The method of claim 7, wherein the financial incentive comprises one or more of a coupon, a discount, a gift card, and rewards points.

9. The method of claim 7, further comprising:
using one or more server computers, facilitating a sale of a software application to the user at least partly in exchange for the financial incentive, wherein the software application is configured to run on the mobile electronic device.

10. A system comprising:
one or more server computers coupled to a network; and
one or more databases coupled to the one or more server computers;
wherein the one or more server computers are for:
receiving an indication from a mobile electronic device that the mobile electronic device is currently being charged, the indication including usage information of the mobile electronic device during a time period between a time when the mobile electronic device was last charged and a time of the current charge;
determining one or more targeting criteria based at least in part on the usage information;
selecting an advertisement based at least in part on the one or more targeting criteria; and
transmitting the advertisement to the mobile electronic device for display on the mobile electronic device, wherein the advertisement is displayed for a predetermined duration while the mobile electronic device is being charged.

11. The system of claim 10, wherein the usage information comprises types of applications used and type of online content viewed during the time period between the last charge and the current charge.

12. The system of claim 10, wherein determining the targeting criteria further comprises determining the targeting criteria based at least in part on user profile information.

13. The system of claim 10, wherein the indication includes location information.

14. The system of claim 13, wherein determining the targeting criteria further comprises determining the targeting criteria based at least in part on the location information.

15. The system of claim 10, wherein the predetermined duration is a duration of the current charge.

16. The system of claim 10, wherein the one or more server computers are further configured for:
using one or more server computers, providing a financial incentive to a user in exchange for allowing the advertisement to be displayed on the mobile electronic device.

17. The system of claim 16, wherein the financial incentive comprises one or more of a coupon, a discount, a gift card, and rewards points.

18. The system of claim 16, wherein the one or more server computers are further configured for:
using one or more server computers, facilitating a sale of a software application to the user at least partly in exchange for the financial incentive, wherein the software application is configured to run on the mobile electronic device.

19. The system of claim 10, wherein the one or more server computers are further configured for:
using one or more server computers, allowing a user to select one or more categories of advertisements; and
wherein selecting the advertisement comprises selecting the advertisement based on the one or more categories.

20. A non-transitory computer readable medium having stored thereon instructions for causing a computer to execute a method, the method comprising:
receiving an indication from a mobile electronic device that the mobile electronic device is currently being charged, the indication including usage information of the mobile electronic device during a time period between a time when the mobile electronic device was last charged and a time of the current charge;
determining one or more targeting criteria based at least in part on the usage information;
selecting an advertisement based at least in part on the one or more targeting criteria;
transmitting the advertisement to the mobile electronic device for display on the mobile electronic device, wherein the advertisement is displayed for a predetermined duration while the mobile electronic device is being charged;
providing a financial incentive to a user in exchange for allowing the advertisement to be displayed on the mobile electronic device; and
facilitating a sale of a software application to the user at least partly in exchange for the financial incentive, wherein the software application is configured to run on the mobile electronic device.
